(19) United States
(12) Patent Application Publication
(10) Pub. No.: US 2025/0348319 A1
(43) Pub. Date: Nov. 13, 2025

(54) Instruction Caching Scheme for High Performance RISC Processors

(71) Applicant: Tenstorrent USA, Inc., Austin, TX (US)

(72) Inventors: Ashok T. Venkatachar, Fremont, CA (US); Vignyan Kothinti, Redmond, WA (US); Rahul Behl, Jammu (IN)

(21) Appl. No.: 18/951,978

(22) Filed: Nov. 19, 2024

Related U.S. Application Data
(60) Provisional application No. 63/644,700, filed on May 9, 2024.

(51) Int. Cl. G06F 9/38

(52) U.S. Cl. CPC G06F 9/3822; G06F 9/3816; G06F 9/3844

(57) ABSTRACT

Systems and methods related to instruction caching schemes are disclosed herein. A set of leading groups of bits in a set of instructions from a cache may be evaluated, in parallel and using a pre-decoder circuit, at a set of locations in the set of instructions. The set of locations may be spaced apart by a length of the smallest expected instruction and the lengths of the expected instructions may be multiples of the length of the smallest expected instruction. A set of instruction sizes associated with the set of locations may be determined from the set of leading groups of bits and stored in a set of entries in a pre-decoded instruction cache. The instructions may be decoded using a decoder circuit and the set of entries. The pre-decoded instruction cache and the pre-decoding processes may reduce the latency of decoding instructions.

### CROSS REFERNECE TO RELATED APPLICATIONS

This application claims the benefit of U.S. Provisional Patent Application No. 63/644,700 filed on May 9, 2024, which is incorporated by reference herein in its entirety for all purposes.

### BACKGROUND

Instruction caching is a pivotal mechanism within computer processors aimed at enhancing performance by storing program instructions closer to the processor core for rapid retrieval. When a program is executed, its instructions are fetched from memory and temporarily stored in the instruction cache. By keeping frequently accessed instructions readily available, the processor can execute them without the latency incurred by fetching them from the slower main memory. As a result, instruction caching significantly reduces the average time required to execute instructions, thereby boosting overall system performance. Modern processors employ sophisticated caching techniques, including multi-level caches, to further optimize performance. In high performance applications, access times from the fastest layer of the cache are generally kept to a maximum of 1 or 2 clock cycles.

Before instructions can be executed by a processor, the instructions must be decoded, which involves the execution circuitry of the processor (e.g., a decoder) analyzing the instructions to determine how they should be executed. Processors which utilize instructions of variable lengths are faced with a more difficult design challenge in this regard which can be referred to as the chaining problem. The variable lengths of the instructions mean that it is difficult to process them in parallel as the decoder cannot easily determine where the start of each instruction is in a block of data that has been retrieved from the cache. For example, in an x86 architecture, instructions can range in length from 1 byte to as many as 15 bytes. As such, if the decoder is provided with a block of 16 bytes from the instruction cache, the decoder may have to evaluate those 16 bytes in a chain to figure out where the start of each instruction is in the block of data. In the alternative, if the decoder knew that each instruction was 1 byte long, the decoder would know where each instruction was in the block of 16 bytes and could process the instructions all at once in parallel.

Some processing architectures avoid the chaining problem altogether by having fixed length instructions. For example, the RISC-V instruction set architecture has a fixed length of 4-bytes per instructions. However, there are certain advantages to having a flexible instruction set architecture that allows for instructions of different lengths such as more compact encoding, enhanced code density, more efficient use of memory bandwidth, and other advantages. Accordingly, even in the context of the RISC-V instruction set architecture, there is an extension of the standard instruction set which is referred to as the C-Extension which allows for either the standard 4-byte instructions or “compressed” instructions that are 2-bytes in length. Processors that follow the RISC-V C-Extension must be able to process chains of instructions having both 4-byte and 2-byte instructions.

### SUMMARY

Systems and methods related to instruction caching and decoding in computer processors are disclosed herein. While the example of a RSIC-V processor which utilizes both 2-byte length and 4-byte length instructions is used as an example throughout this disclosure, the approaches disclosed herein are broadly applicable to any processor with variable length instructions. In specific embodiments of the invention, methods and systems are provided that utilize a pre-decoded instruction cache which stores information derived from a pre-decoding process conducted on instructions before they are decoded. The instructions can be provided from a cache for this pre-decoding process. In specific embodiments, the pre-decoding can harvest branching information from the instructions which is then stored in an entry in the pre-decoded instruction cache. In specific embodiments, the pre-decoding can harvest instruction length information from the instructions which is then stored in the pre-decoded instruction cache.

Using the approaches disclosed herein, information harvested from a pre-decoding step can be applied to dramatically improve the performance of the process of decoding instructions. For example, in the context of a RISC-V processor using compressed or uncompressed instructions, a typical decode process involves two clock cycles to fetch the instructions from memory, one clock cycle to determine which instructions are compressed or not, one clock cycle to conduct a chaining operation to find the start of each instruction, and another clock cycle to do final decoding and branch handling. The result is a latency of 5 clock cycles. In contrast, using some of the approaches disclosed herein, fetching the instructions can be done in one clock cycle and chaining can be done in a second clock cycle. The result is a latency of two clock cycles. This benefit is realized through the introduction of a pre-decoded instruction cache and the pre-decoding processes disclosed herein. Furthermore, specific approaches for the pre-decoding step are disclosed herein which make the pre-decoding process itself highly efficient.

In specific embodiments of the invention, a method is provided. The method comprises: fetching a set of instructions from a cache line in a cache and evaluating, in parallel and using a pre-decoder circuit, a set of leading groups of bits in the set of instructions at a set of locations in the set of instructions, wherein the set of locations are spaced apart by a length of a smallest expected instruction in the set of instructions, and wherein lengths of expected instructions in the set of instructions are multiples of the length of the smallest expected instruction. The method further comprises: determining, from the set of leading groups of bits, a set of instruction sizes associated with the set of locations; storing data indicative of the set of instruction sizes in a set of entries in a pre-decoded instruction cache; and decoding the set of instructions using a decoder circuit and the set of entries.

In specific embodiments of the invention, a system is provided. The system comprises: a cache including a cache line storing a set of instructions; and a pre-decoder circuit that evaluates, in parallel, a set of leading groups of bits in the set of instructions at a set of locations in the set of instructions, wherein the set of locations are spaced apart by a length of a smallest expected instruction in the set of instructions, and wherein lengths of expected instructions in the set of instructions are multiples of the length of the smallest expected instruction. The system further comprises a pre-decoded instruction cache that stores data indicative of a set of instruction sizes in a set of entries, wherein the set of instruction sizes associated with the set of locations is determined from the set of leading groups of bits. The system further comprises a decoder circuit that decodes the set of instructions using the set of entries.

In specific embodiments of the invention, a system is provided. The system comprises: a means for fetching a set of instructions from a cache line in a cache; and a means for evaluating, in parallel and using a pre-decoder circuit, a set of leading groups of bits in the set of instructions at a set of locations in the set of instructions, wherein the set of locations are spaced apart by a length of a smallest expected instruction in the set of instructions, and wherein lengths of expected instructions in the set of instructions are multiples of the length of the smallest expected instruction. The system further comprises: a means for determining, from the set of leading groups of bits, a set of instruction sizes associated with the set of locations; a means for storing data indicative of the set of instruction sizes in a set of entries in a pre-decoded instruction cache; and a means for decoding the set of instructions using a decoder circuit and the set of entries.

### BRIEF DESCRIPTION OF THE DRAWINGS

The accompanying drawings illustrate various embodiments of systems, methods, and various other aspects of the disclosure. A person with ordinary skill in the art will appreciate that the illustrated element boundaries (e.g., boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 provides a block diagram of a system including a cache, a pre-decoder circuit, a pre-decoded instruction cache, a decoder circuit, and an instruction cache in accordance with specific embodiments of the inventions disclosed herein.

FIG. 2 provides a block diagram of a system including a cache, a pre-decoder circuit, a pre-decoded instruction cache, and 2-byte instructions in accordance with specific embodiments of the inventions disclosed herein.

FIG. 3 provides a block diagram of a system including a cache, a pre-decoder circuit, a pre-decoded instruction cache, a cache line, and variable-length instructions in accordance with specific embodiments of the inventions disclosed herein.

FIG. 4 provides an example of an entry of a pre-decoded instruction cache in accordance with specific embodiments of the inventions disclosed herein.

FIG. 5 provides an example of an uncompressed instruction and a compressed instruction performing the same operation of adding an immediate value to a value stored at a register and storing the result at the same register in accordance with specific embodiments of the inventions disclosed herein.

FIG. 6 provides an example of an uncompressed branching instruction and a compressed branching instruction performing the same operation of comparing a value in a register to zero in accordance with specific embodiments of the inventions disclosed herein.

FIG. 7 provides an example of an invalid header in the middle of a 4-byte instruction and a header erroneously corresponding to a branch instruction in the middle of a second 4-byte instruction in accordance with specific embodiments of the inventions disclosed herein.

FIG. 8 provides aa flowchart for a method of decoding instructions in accordance with specific embodiments of the inventions disclosed herein.

FIG. 9 provides an example of a cache line on which the flowchart of FIG. 8 may operate, in accordance with specific embodiments of the inventions disclosed herein.

FIG. 10 provides an example of a method of performing an instruction caching scheme in accordance with specific embodiments of the inventions disclosed herein.

### DETAILED DESCRIPTION

Reference will now be made in detail to implementations and embodiments of various aspects and variations of systems and methods described herein. Although several exemplary variations of the systems and methods are described herein, other variations of the systems and methods may include aspects of the systems and methods described herein combined in any suitable manner having combinations of all or some of the aspects described.

Different systems and methods for instruction caching and decoding in computer processors in accordance with the summary above are described in detail in this disclosure. The methods and systems disclosed in this section are nonlimiting embodiments of the invention, are provided for explanatory purposes only, and should not be used to constrict the full scope of the invention. It is to be understood that the disclosed embodiments may or may not overlap with each other. Thus, part of one embodiment, or specific embodiments thereof, may or may not fall within the ambit of another, or specific embodiments thereof, and vice versa. Different embodiments from different aspects may be combined or practiced separately. Many different combinations and sub-combinations of the representative embodiments shown within the broad framework of this invention, that may be apparent to those skilled in the art but not explicitly shown or described, should not be construed as precluded.

Systems and methods related to instruction caching and decoding in computer processors are disclosed herein. While the example of a RSIC-V processor which utilizes both 2-byte length and 4-byte length instructions is used as an example throughout this disclosure, the approaches disclosed herein are broadly applicable to any processor with variable length instructions. In specific embodiments of the invention, methods and systems are provided that utilize a pre-decoded instruction cache which stores information derived from a pre-decoding process conducted on instructions before they are decoded. The instructions can be provided from a cache for this pre-decoding process. In specific embodiments, the pre-decoding can harvest branching information from the instructions which is then stored in an entry in the pre-decoded instruction cache. In specific embodiments, the pre-decoding can harvest instruction length information from the instructions which is then stored in the pre-decoded instruction cache.

Systems related to instruction caching and decoding in computer processors as disclosed herein may include one or more caches, pre-decoder circuits, pre-decoded instruction caches, decoder circuits, and instruction caches. An instruction cache may store a set of instructions in a cache line. The cache line can store instructions of various lengths such as 2-byte compressed instructions and 4-byte uncompressed instructions in a RISC-V processor, or other lengths for different instruction set architectures. A pre-decoder circuit can be coupled to a read port of the instruction cache and a write port of a pre-decoded instruction cache. In specific embodiments of the invention, a pre-decoder circuit is configured to read a set of instructions from a cache line of a cache, generate a set of entries for the set of instructions, and write the set of entries to a pre-decoded instruction cache. In specific embodiments, the pre-decoder circuit and the instruction cache can access the cache line in parallel.

The pre-decoded instruction cache can store a set of entries associated with a set of locations in the cache line, many of which correspond to headers of instructions. Each entry can be associated with a set of locations in the set of instructions and may not be associated with specific instructions because the content of the cache line of instructions has not yet been determined during the pre-decoding. Some entries may be associated with a set of locations in the cache line which do not correspond to headers of instructions. For example, these entries may be associated with bits in the middle (e.g., not at the beginning) of an instruction. These entries associated with “random” bits may correspond to invalid headers or to valid headers that do not actually correspond to real instructions, errors related to these “random” bits may be resolved at a later time (e.g., after the entries are stored for the set of locations in the cache line). Each entry that does correspond to an instruction header may include information regarding its corresponding instruction. For example, the entry can indicate what type of instruction the instruction is, whether the instruction has a specific length (e.g., whether the instruction is compressed or uncompressed), what the length of the instruction is, if the instruction is a branching instruction, what type of branching instruction the instruction is, etc. The entries can include any information that can assist a decoding circuit in decoding the instructions.

The pre-decoder circuit can be coupled to the cache by an addressable bus that delivers either an entire cache line or a part thereof to registers of the pre-decoder circuit. The pre-decoder circuit can include combinatorial logic and an optional lookup table to compare the values of the set of instructions (e.g., the locations) to determine values for the entries. The pre-decoder circuit can have the inputs to the combinatorial logic spaced apart across the registers (e.g., caches) that hold the set of instructions. For example, the connections could connect the combinatorial logic to a location where the header of an instruction is expected to be (e.g., every 2 bytes a connection could be made to 7 bits of the cache line or instruction).

In specific embodiments of the invention, the entries in the pre-decoded instruction cache can be smaller than the instructions themselves. This is because the entries can contain information summarizing the instructions and can be encoded in dense format (e.g., a single bit to identify if the instruction is compressed or not, three bits to identify the instruction type, etc.). For example, a 32-byte cache line could include 16 16-bit (2-byte) instructions. In this example, the pre-decoded instruction cache could include 16 4-bit entries meaning that the entries were a quarter of the size of the original instructions. In these embodiments, data regarding the instructions can be fetched from the pre-decoded instruction cache more rapidly than from the instruction cache with hardware bus sizes held constant.

Using the approaches disclosed herein, information harvested from a pre-decoding step can be applied to dramatically improve the performance of the process of decoding instructions. For example, in the context of a RISC-V processor using compressed or uncompressed instructions, a typical decode process involves two clock cycles to fetch the instructions from memory, one clock cycle to determine which instructions are compressed or not, one clock cycle to conduct a chaining operation to find the start of each instruction, and another clock cycle to do final decoding and branch handling. The result is a latency of 5 clock cycles. In contrast, using some of the approaches disclosed herein, fetching the instructions can be done in one clock cycle and chaining can be done in a second clock cycle. The result is a latency of two clock cycles. This benefit is realized through the introduction of a pre-decoded instruction cache and the pre-decoding processes disclosed herein. Furthermore, specific approaches for the pre-decoding step are disclosed herein which make the pre-decoding process itself highly efficient.

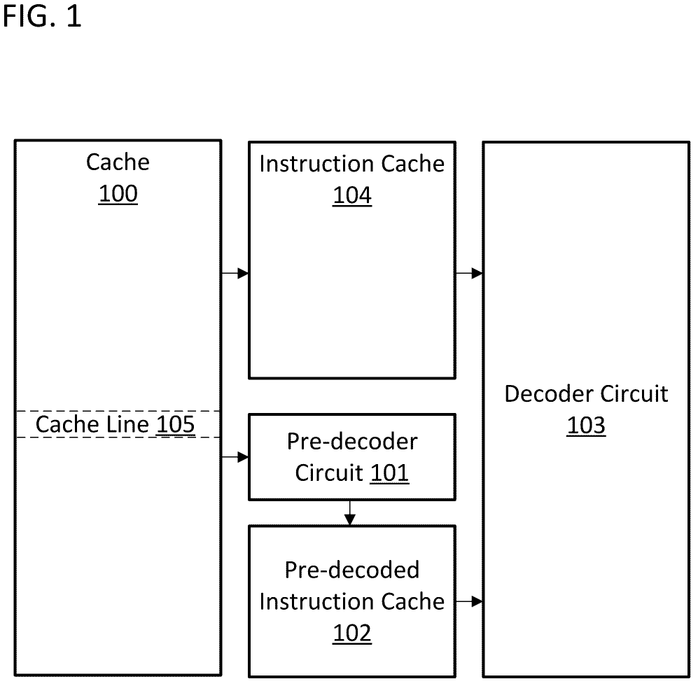

FIG. 1 illustrates a block diagram of a system including cache 100, pre-decoder circuit 101, pre-decoded instruction cache 102, decoder circuit 103, and instruction cache 104 that can be used to illustrate aspects of specific embodiments of the inventions disclosed herein. Cache 100 can be a lower-level cache than instruction cache 104. For example, the cache can be a level 2 (L2) cache which is used to cache both data and instructions for a processor. As illustrated, the cache stores a set of instructions in cache line 105. For example, the cache line can be a 64-byte long cache line. Cache line 105 can store instructions of various lengths such as 2-byte compressed instructions and 4-byte uncompressed instructions in a RISC-V processor. Pre-decoder circuit 101 can be coupled to a read port of cache 100 and a write port of pre-decoded instruction cache 102.

Pre-decoded instruction cache 102 can store a set of entries associated with the set of instructions in cache line 105. The set of entries can store data regarding the instructions in the set of instructions in cache line 105. The association can be a one-to-one correspondence where pre-decoded instruction cache 102 can be accessed to obtain an entry for each instruction in cache line 105. As will be described below, in specific embodiments, each entry can be associated with a set of locations in the set of instructions and are not associated with specific instructions because the content of the cache line of instructions has not yet been determined during the pre-decoding.

Each entry in the set of entries of pre-decoded instruction cache 102 can include information regarding an instruction, or a location, in the set of instructions. For example, the entry can indicate what type of instruction the instruction is, whether the instruction has a specific length, what the length of the instruction is, if the instruction is a branching instruction, what type of branching instruction the instruction is, etc. The entries can include any information that can assist a decoding circuit in decoding the instruction. In specific embodiments in which the processor is a RSIC-V processor, the entry can indicate if an instruction is a 2-byte compressed instruction or a 4-byte uncompressed instruction. In specific embodiments, the entry can indicate what type of branching instruction the instruction is. In specific embodiments of the invention, the entries of pre-decoded instruction cache 102 are 4-bit entries with one bit indicating if the instruction is a compressed instruction or an uncompressed instruction, and the remaining 3-bits indicating what type of branching instruction the instruction is. In specific embodiments in which the entry tracks what type of branching instruction the instruction is, a single value of the entry can indicate if the instruction is not a branching instruction.

In specific embodiments of the invention, the entries for the instructions, in pre-decoded instruction cache 102, can be smaller than the instructions themselves. This is because the entries can contain information summarizing the instructions and can be encoded in dense format (e.g., a single bit to identify if the instruction is compressed or not etc.). For example, a 32-byte cache line could be half of a 64-byte block of instructions and could include 16 2-byte (16 bit) instructions. In this example, the pre-decoded instruction cache could include 16 4-bit entries meaning that the entries were a quarter of the size of the original instructions. In these embodiments, data regarding the instructions can be fetched from the pre-decoded instruction cache more rapidly than from the instruction cache with hardware bus sizes held constant. For example, an entire 64-byte block of instructions that may have taken 2 clock cycles to fetch from the instruction memory can be pre-decoded such that the associated entries, which may represent only 16-bytes of information, can be read from the pre-decoded instruction cache to be used to decode the instructions in a single clock cycle.

In specific embodiments of the invention, a pre-decoder circuit (e.g., pre-decoder circuit 101) may be configured to fetch (e.g., read) a set of instructions from a cache line (e.g., cache line 105) of a cache (e.g., cache 100), evaluate a set of leading groups of bits in the set of instructions at a set of locations in the set of instructions, determine a set of instruction sizes associated with the set of locations, and store (e.g., write) the set of entries to a pre-decoded instruction cache (e.g., pre-decoded instruction cache 102). The set of entries may include data indicative of the set of instruction sizes. In specific embodiments, the evaluating of the set of leading groups of bits, the determining of the set of instruction sizes, and the storing of the data indicative of the set of instruction sizes are all conducted together in a single clock cycle. In specific embodiments of the invention, the set of locations may be spaced apart by a length of a smallest expected instruction in the set of instructions, and lengths of expected instructions in the set of instructions may be multiples of the length of the smallest expected instruction. Determining the set of instruction sizes associated with the set of locations may be based on the set of leading groups of bits.

In specific embodiments, the pre-decoder circuit and the instruction cache (e.g., pre-decoder circuit 101 and instruction cache 104) can access the cache line in parallel. The pre-decoder circuit can be configured to conduct those actions by being coupled to the cache by an addressable bus that delivers either an entire cache line or a part thereof to registers of the pre-decoder circuit. The pre-decoder circuit can include combinatorial logic and an optional lookup table to compare the values of the set of instructions to determine values for the entries. As stated above, the entries can indicate if the instructions are compressed or uncompressed, can otherwise indicate the length of the instructions, can indicate if the instruction is a branching instruction, and can indicate what type of branching instruction the instruction is. The pre-decoder circuit can have the inputs to the aforementioned combinatorial logic connected in spaced apart fashion across the registers that hold the set of instructions. For example, the connections could connect the combinatorial logic to a location where the header of an instruction is expected to be (e.g., every 2 bytes a connection could be made to 7 bits of the instruction).

The system of FIG. 1 may decode the set of instructions using decoder circuit 103 and the set of entries. The system may determine if any location in the set of locations of cache 100 was not aligned with any instruction in the set of instructions using the data indicative of the set of instruction sizes. Determining if any location in the set of locations was not aligned with any instruction in the set of instructions may be conducted within a single clock cycle. The system of FIG. 1 may also evaluate a set of headers of the set of instructions using the data indicative of the set of instruction sizes.

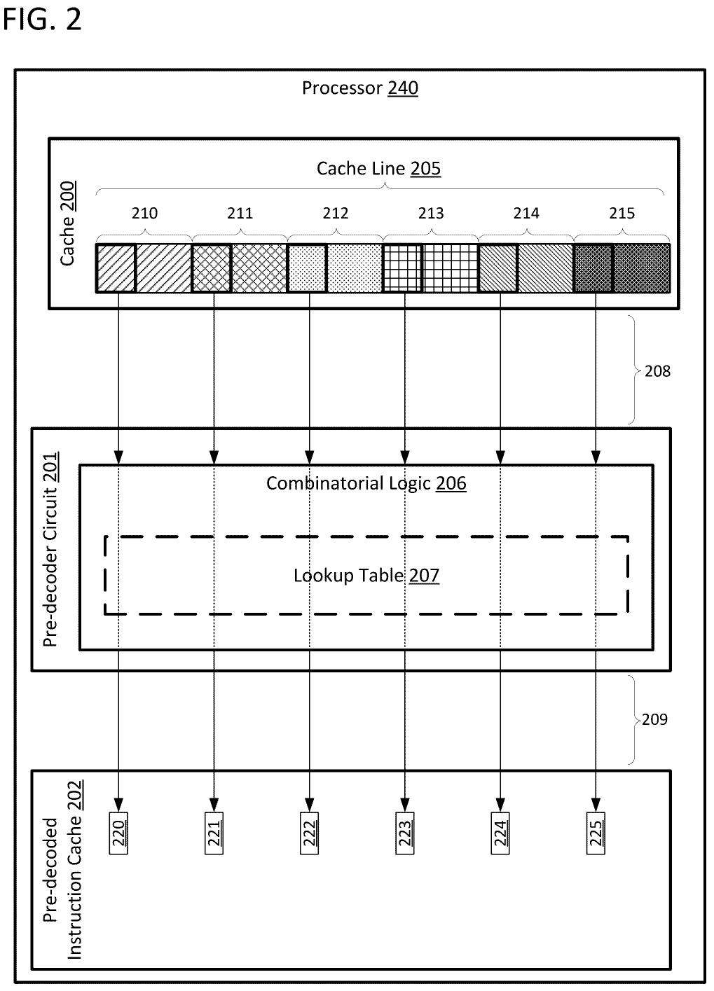

FIG. 2 illustrates a block diagram of a system including cache 200, pre-decoder circuit 201, pre-decoded instruction cache 202, cache line 205, and 2-byte instructions 210, 211, 212, 213, 214, and 215 that can be used to illustrate aspects of specific embodiments of the inventions disclosed herein. Aspects of the system of FIG. 2 may be similar to aspects of the system of FIG. 1. For example, cache 200 may be similar to cache 100, pre-decoder circuit 201 may be similar to pre-decoder circuit 101, pre-decoded instruction cache 202 may be similar to pre-decoded instruction cache 102, and cache line 205 may be similar to cache line 105. Cache 200 may be a lower-level cache. Cache line 205 can be a 64-byte long cache line although only 12 bytes are shown for simplicity. In the example of FIG. 2, each instruction 210, 211, 212, 213, 214, and 215 is 2-bytes. The system of FIG. 2 may include processor 240, which may be a RISC-V processor. In specific embodiments, processor 240 may conduct the operations and methods described. Pre-decoder circuit 201 can be coupled to a read port of cache 200 (via connections 208) and a write port of pre-decoded instruction cache 202 (via connections 209). Connections 208 may run from registers (e.g., of cache 200) where the instruction bits are stored to pre-decoder circuit 201. Pre-decoder circuit 201 may have lookup table 207 (e.g., one or more lookup tables) and one or more blocks of combinatorial logic 206 to compare the data in the registers (e.g., concerning instructions 210 through 215) to data in lookup table 207. For example, pre-decoder circuit 201 may determine the set of instruction sizes using lookup table 207 and combinatorial logic 206. Outputs of combinatorial logic 206 may be routed to be stored in pre-decoded instruction cache 202 via connections 209.

Pre-decoder circuit 201 can have connections 208 (e.g., inputs to combinatorial logic 206) connected in spaced apart fashion across the registers that hold the set of instructions 210 through 215. Each connection 208 may be an addressable bus that delivers all or part of cache line 205 to registers of pre-decoder circuit 201. Connections 208 could connect combinatorial logic 206 to a location where the header (e.g., opcode) of an instruction is expected to be. For example, each connection 208 may allow pre-decoder circuit 201 to read the first 7 bits of every 2 bytes. As shown in FIG. 2, the portions of instructions 210 through 215 that are read by pre-decoder circuit 201 are outlined (e.g., the first 7 bits of each instruction, 7 bits every 2 bytes). In the example of FIG. 2, each instruction 210 through 215 is 2 bytes. Accordingly, pre-decoder circuit 201 reads the first 7 bits of every instruction 210 through 215. The first 7 bits of instructions 210 through 215 may be referred to as leading groups of bits. Instructions 210 through 215 are exemplary only, as more or less instructions may be in a cache line and instructions may have different lengths.

In specific embodiments of the invention, pre-decoder circuit 201 is configured to fetch a set of instructions 210 through 215 from cache line 205 of cache 200, evaluate a set of leading groups of bits in the set of instructions 210 through 215, determine a set of instruction sizes associated with the set of locations, generate a set of entries 220, 221, 222, 223, 224, and 225 for the set of instructions 210, 211, 212, 213, 214, and 215 respectively, and store the set of entries 220 through 225 to pre-decoded instruction cache 202. Pre-decoder circuit 201 can be configured to conduct those actions. In specific embodiments, the evaluating of the set of leading groups of bits, the determining of the set of instruction sizes, and the storing of the data indicative of the set of instruction sizes are all conducted together in a single clock cycle.

Pre-decoder circuit 201 can include combinatorial logic 206 and lookup table 207 (optional) to compare the values of the set of instructions to determine values to output to pre-decoded instruction cache 202 as entries 220 through 225. Pre-decoder circuit 201 may determine, from the set of leading groups of bits, the branch instruction types associated with the set of locations and store data indicative of the branch instruction types in the set of entries 220 through 225 in pre-decoded instruction cache 202. Entries 220 through 225 can indicate if the corresponding instruction 210 through 215 is compressed or uncompressed, can otherwise indicate the length of the corresponding instruction 210 through 215, can indicate if the corresponding instruction 210 through 215 is a branching instruction, and can indicate what type of branching instruction the instruction is (if any).

Pre-decoder circuit 201 may be coupled to a write port of pre-decoded instruction cache 202 to write entries 220 through 225 via connections 209. Each connection 209 may be an addressable bus in order to store the set of entries 220 through 225 in an address in pre-decoded instruction cache 202 that is associated with the address for cache line 205 corresponding to the associated instruction 210 through 215.

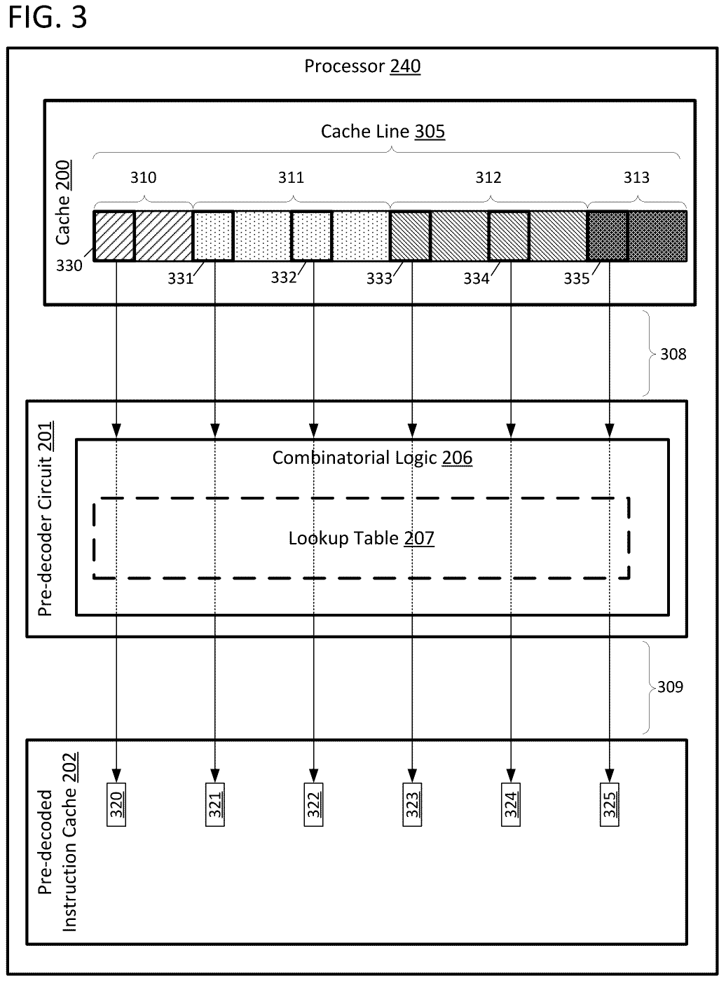

FIG. 3 illustrates a block diagram of a system including cache 200, pre-decoder circuit 201, pre-decoded instruction cache 202, cache line 305, and variable-length instructions (2-byte and 4-byte instructions) that can be used to illustrate aspects of specific embodiments of the inventions disclosed herein. Aspects of the system of FIG. 3, including the functions of various components, may be similar to aspects of the system of FIG. 2. Cache line 305 may hold any number of bits, although only 12 bytes are shown for simplicity. In the example of FIG. 3, instruction 310 is 2-bytes, instruction 311 is 4-bytes, instruction 312 is 4-bytes, and instruction 313 is 2-bytes. Each 2-byte instruction may be a compressed instruction and each 4-byte instruction may be an uncompressed instruction. The system of FIG. 3 may include processor 240, which may be a RISC-V processor. In specific embodiments, processor 240 may conduct the operations and methods described.

Pre-decoder circuit 201 can be coupled to a read port of cache 200 (via connections 308) and a write port of pre-decoded instruction cache 202 (via connections 309). Each connection 308 may be an addressable bus that delivers all or part of cache line 305 to registers of pre-decoder circuit 201. Each connection 309 may be an addressable bus in order to store the set of entries 320, 321, 322, 323, 324, and 325 in an address in pre-decoded instruction cache 202 that is associated with the address for cache line 305 corresponding to the leading groups of bits 330, 331, 332, 333, 334, and 335 respectively. Instructions 310 through 313 are exemplary only, as more or less instructions may be in a cache line with different patterns of instruction lengths.

Pre-decoder circuit 201 can have connections 308 (e.g., inputs to combinatorial logic 206) connected in spaced apart fashion across the registers that hold the set of instructions 310 through 314. For example, connections 308 could connect combinatorial logic 206 to a location where the header (e.g., opcode) of an instruction is expected to be. In the example of FIG. 3, the system may expect an instruction header every 2 bytes, as the minimum expected instruction length may be 2 bytes, and each length of other expected instructions may have a length that is an integer multiple of 2 bytes (e.g., 4 bytes, 6 bytes, 8 bytes). Each connection 308 may allow pre-decoder circuit 201 to read the leading groups of bits (e.g., the first 7 bits of every 2 bytes) FIG. 3 shows leading groups of bits 330, 331, 332, 333, 334, and 335 outlined with thick borders.

In the example of FIG. 3, the instructions have variable length, however each instruction may be an integer multiple of the smallest instruction. For example, instruction 311 and instruction 312 are each 4-bytes, precisely twice as long as instruction 310 and instruction 313, each of which are 2-bytes. Leading groups of bits 330, 331, 333, and 335 correspond to the headers of instructions 310 through 313. Leading groups of bits 332 and 334 are in the middle of instructions 311 and 312 and thus are not aligned with any instructions (e.g., do not correspond to instruction headers). In specific embodiments, processor 240 may determine that the locations in cache 200 corresponding to leading groups of bits 332 and 334 are not aligned with any instructions. For example, processor 240 may determine that a location 2 bytes after a 4-byte instruction is not aligned with any instruction. Processor 240 may also determine that the leading bits do not decode as a valid instruction header.

In specific embodiments of the invention, pre-decoder circuit 201 may be configured to generate a set of entries 320, 321, 322, 323, 324, and 325 for the set of instructions 310, 311, 312, and 313, and write the set of entries 320 through 325 to pre-decoded instruction cache 202. Entries 320 through 325 may be generated and written regardless of whether the corresponding leading groups of bits 330 through 335 refer to instruction headers or bits in the middle of an instruction. Pre-decoder circuit 201 may be unaware of whether the leading groups of bits 330 through 335 refer to headers or to non-header fields. For example, instructions 310 through 313 may not yet be decoded, and it may not be clear where all the instructions start along the cache line 305 during the pre-decoding process. Additionally, pre-decoder circuit 201 may generate entries 320 through 325 in parallel.

Entries 322 and 324, referring to bits in the middle of instructions 311 and 312 respectively, may be discarded or resolved later. For example, entries 322 and 324 may be resolved when chaining the instructions during a decode operation. In specific embodiments, the erroneous entries 322 and 324 may not be resolved and the processor may identify an invalid instruction during execution and may conduct a flush operation to revolve the error. In specific embodiments of the invention, when pre-decoder circuit 201 generates entries for the leading groups of bits, each leading group of bits may indicate the length of the corresponding instruction (if the leading group of bits corresponds to the header of the instruction). For example, the leading group of bits may indicate if the instruction is a compressed instruction or an uncompressed instruction. As such, entries in pre-decoded instruction cache 202 may be able to identify which instructions are 2-byte and which are 4-byte. However, the parallel searches will also read data at a specific location, which they assume to be leading sets of bits, but that are actually bits in the center of (e.g., not aligned with) an instruction. If an instruction is identified as 4-bytes, then the group of leading bits subsequent to (e.g., 2 bytes after) that instruction may be discarded. For example, if instruction 311 is recognized as a 4-byte instruction in entry 321, then entry 322, which refers to a location only 2-bytes after instruction 311, necessarily must refer to bits in the middle of instruction 311. Accordingly, entry 322 does not refer to an instruction header or opcode and may be resolved, discarded, or otherwise ignored.

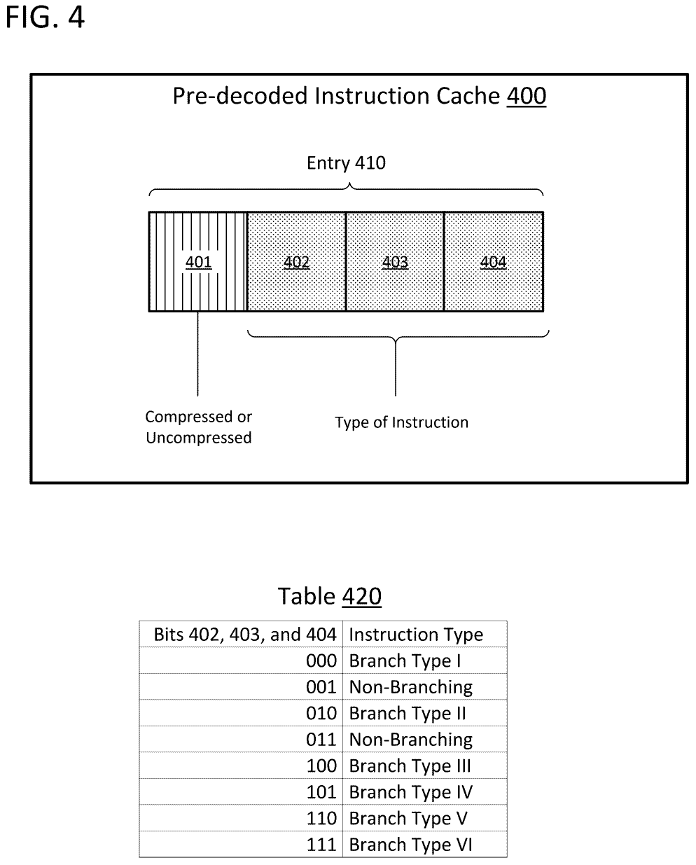

FIG. 4 illustrates an example of entry 410 of pre-decoded instruction cache 400 in accordance with specific embodiments of the inventions disclosed herein. Entry 410 may include 4 bits: bit 401, bit 402, bit 403, and bit 404. Pre-decoded instruction cache 400 can store a set of entries associated with the set of instructions in a cache line (e.g., cache line 105, cache line 205), although only one entry 410 corresponding to one instruction is shown. Entries and instructions can be associated in a one-to-one correspondence where pre-decoded instruction cache 400 can be accessed to obtain an entry for each instruction in the cache line. Each entry can be associated with a set of locations in the set of instructions and may not be associated with specific instructions because the content of the cache line of instructions may not yet be determined while the entries are generated and stored. That is, entry 410 may be associated with a location in a cache line that corresponds to an instruction rather than being associated with the instruction directly.

Entry 410 of pre-decoded instruction cache 400 can include information regarding an instruction, or a location, in the set of instructions. For example, entry 410 can indicate what type of instruction the corresponding instruction is, whether the instruction has a specific length, what the length of the instruction is, if the instruction is a branching instruction, what type of branching instruction the instruction is, etc. Entry 410 can include any information that can assist a decoding circuit in decoding the instruction. In specific embodiments in which the processor is a RSIC-V processor, entry 410 can indicate (e.g., via bit 401) if an instruction is a 2-byte compressed instruction or a 4-byte uncompressed instruction. In specific embodiments, entry 410 can indicate what type of branching instruction the instruction is. In specific embodiments of the invention, entry 410 of pre-decoded instruction cache 400 is 4-bits. Bit 401 may indicate if the instruction is a compressed instruction or an uncompressed instruction. Bits 402, 403, and 404 may indicate what type of branching instruction the instruction is. In specific embodiments, bits 402, 403, and 404 indicate the instruction type of the corresponding instruction (e.g., R-type, I-type, S-type B-type, U-type, J-type, etc.).

In specific embodiments, bits 402, 403, and 404 may indicate whether the instruction is a branching instruction and what type of branching instruction the instruction is (if any). Table 420 offers an example of how bits 402, 403 and 404 may identify instructions. If bit 402, bit 403, and bit 404 are each “0”, then entry 410 may refer to an instruction of branch type I. If bit 402 is “1,” bit 403 is “0,” and bit 404 is “1,” then entry 410 may refer to an instruction of branch type IV. Branch types may include BEQ, BNE, BLT, BGE, BLTU, BGEU, C.BEQX, and C.BNEZ for example. Bits 402, 403, and 404, may also correspond to a non-branching instruction. For example, if bit 402 is “0,” bit 403 is “1,” and bit 404 is “1,” then entry 410 may refer to a non-branching instruction. Non-branching instructions may be, for example, Register format (R-Type), Immediate format (I-Types), Store format (S-type), Upper Immediate formats (U-Type), and Jump format (J-Type).

In specific embodiments, an entry may be fewer or more than 4 bits. In specific embodiments in which the entry tracks what type of branching instruction the instruction is, the entry may be 2-bits, with one bit indicating whether the instruction is compressed or uncompressed and another bit indicating if the instruction is a branching instruction or not a branching instruction. In specific embodiments, an entry may be a single bit indicating whether the instruction is compressed or uncompressed (e.g., indicating the length of the instruction). In specific embodiments, an entry may be more than 4 bits, where the bits provide more information about the type of instruction the entry corresponds to (e.g., subcategories of R-type instructions, subcategories of I-type instructions, etc.).

Entry 410 may be smaller than the instruction it corresponds to, as entry 410 contains information summarizing the instruction and can be encoded in dense format (e.g., a single bit to identify if the instruction is compressed or not etc.). For example, a 2-byte (16 bit) instruction may be represented by 4-bit entry 410. In this example, entry 410 is a quarter of the size of the original instruction. Data from entry 410 regarding the instruction can be fetched from pre-decoded instruction cache 400 more rapidly (e.g., in fewer clock cycles) than the instruction may be fetched from an instruction cache (e.g., with hardware bus sizes held constant).

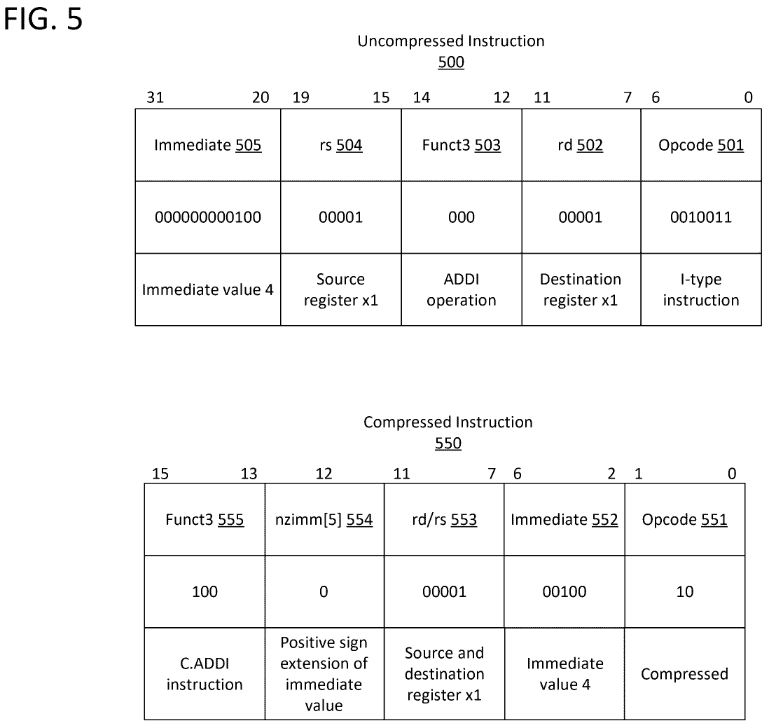

FIG. 5 illustrates an example of uncompressed instruction 500 and compressed instruction 550 performing the same operation of adding immediate value “4” to a value stored at register “x1” and storing the result at register “x1” in accordance with specific embodiments of the inventions disclosed herein. Uncompressed instruction 500 is an ADDI operation and compressed instruction 550 is a C.ADDI operation. The first rows of uncompressed instruction 500 and compressed instruction 550 indicate the fields of groups of bits, the second rows indicate example binary forms of those fields, and the third rows indicate the meanings of the specific binary example.

RISC-V instruction set architecture (ISA) may use several instruction formats. For example, RISC-V may use Register instruction format (R-Type), Immediate instruction format (I-Types), Store instruction format (S-type), Branch instruction format (B-Type), Upper Immediate instruction format (U-Type), and Jump instruction format (J-Type). Whether an instruction is compressed or uncompressed may be determined by the bottom two bits of the least significant byte of the instruction. For example, if both bits are 1 (e.g., 11), the instruction may be uncompressed. Otherwise, the instruction may be compressed (e.g., 00, 01, 10). In specific embodiments, only certain types of instructions may be compressed (e.g., loads, stores, jumps, and arithmetic operations). Compressed instructions may use a subset of registers (e.g., the eight most commonly used registers) to fit within a 16-bit format. Instructions with small immediate values or specific patterns (e.g., zero or small offsets) may be more likely to have compressed versions. Uncompressed instructions may be 32 bits (4 bytes) long and compressed instructions may be 16 bits (2 bytes) long.

Uncompressed instruction 500 includes five different fields. For uncompressed core formats, the first 7 bits ([6:0]) represent the opcode. In FIG. 5, uncompressed opcode 501 is “0010011;” opcode 501 ends with “11,” indicating that the instruction is uncompressed. The entire opcode 501 informs the CPU the format and, depending on the instruction, the exact operation to be performed on the operands. In cases where the opcode does not correspond to a single instruction, it informs the CPU where to look for more information. In the example of FIG. 5, the opcode indicates that instruction 500 is an I-type instruction. A pre-decoder circuit may read the opcode, may determine that instruction 500 is an uncompressed instruction (opcode 501 ends with “11”), and may store this information as an entry in a pre-decoded instruction cache. In specific embodiments, the pre-decoder circuit may also determine that instruction 500 is not a branching type instruction (e.g., that opcode 501 does not correspond to a branching type instruction), that instruction 500 is an I-type instruction (e.g., that opcode 501 matches an I-type instruction), and other information about instruction 500. This information may be stored as part of the entry in the pre-decode instruction circuit.

Other fields of uncompressed instruction 500 include destination register (rd) 502, funct3 503, source register (rs) 504, and immediate value 505. Destination register 502 indicates where the result of the computation will be stored, in this case “00001” or register “x1”. Funct3 503 indicates which operation the instruction refers to, in this case “000” or “ADDI.” Source register 504 indicates where to find one of the operands of the operation, in this case “00001” or register “x1.” Immediate value 505 indicates the other operand of the operation, in this case “000000000100” or the value “4.”

Compressed instruction 550 includes five different fields. For compressed core formats, the first 2 bits ([1:0]) represent the opcode field. In FIG. 5, the opcode 551 is “10,” indicating that the instruction is compressed. A pre-decoder circuit may read the first 7 bits of instruction 550 (including opcode 551) may determine that instruction 550 is a compressed instruction, and may store this information as an entry in a pre-decoded instruction cache. In specific embodiments, the pre-decoder circuit may, based on the determination that instruction 550 is compressed, read additional bits of instruction 550 and discard or ignore portions of the first 7 bits of instruction 550. For example, bits 2-6 of instruction 550 (corresponding to immediate 552) may not be relevant to the pre-decoder circuit and may be ignored, discarded, or resolved. The pre-decoder circuit may read bits 13-15 (funct3 555), which correspond to the instruction type of instruction 550. The pre-decoder circuit may determine that instruction 550 is not a branching type instruction (e.g., funct3 555 does not correspond to a branching type instruction), that instruction 550 is an I-type instruction (e.g., funct3 555 matches an I-type instruction), and other information about instruction 550. This information may be stored as part of the entry in the pre-decode instruction circuit.

Fields of compressed instruction 550 include opcode 551, destination register/source register (rd/rs) 553, funct3 555, nzimm 554 (non-zero immediate), and immediate 552. Immediate 552 indicates an operand of the operation, in this case “00100” or the value “4.” Destination register/source register 553 indicates where the result of the computation will be stored and where to find the other operand of the operation. As destination register/source register 553 is a single field, the operand is found at the same location that the result of the operation will be stored (e.g., once the operation is complete). In this case the destination register and the source register are “00001” or register “x1.” Nzimm 554 indicates the sign extension of immediate 552. As immediate 552 refers to a positive “4” in this example, nzimm 554 is “0.” If the immediate value were a negative number, nzimm would be “1”. Funct3 555 indicates which operation the instruction refers to, in this case “100” or “C.ADDI.” In specific embodiments, fields may contain fewer bits than allotted and padding bits may be added to the instruction such that the compressed instruction length is 16-bits.

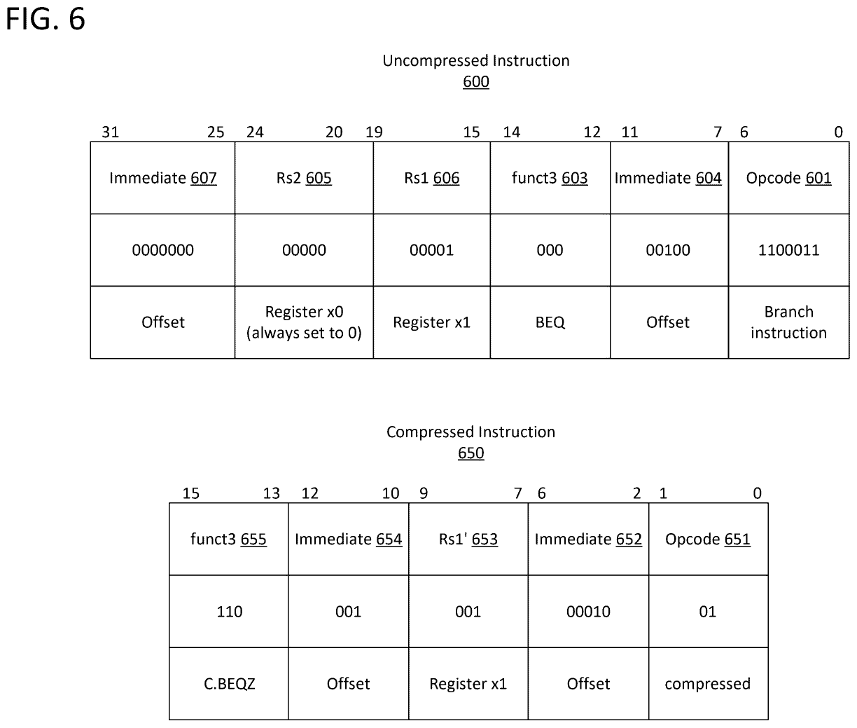

FIG. 6 illustrates an example of uncompressed branching instruction 600 and compressed branching instruction 650 performing the same operation of comparing a value in register “x1” to zero in accordance with specific embodiments of the inventions disclosed herein. Uncompressed instruction 600 is a BEQ operation and compressed instruction 650 is a C.BEQZ operation. The first rows of uncompressed instruction 600 and compressed instruction 650 indicate the fields of groups of bits, the second rows indicate example binary forms of those fields, and the third rows indicate the meanings of the specific binary example.

Branch instructions may compare two registers. For example, BEQ (branch if equal) and BNE (branch if not equal) may take the branch if registers rs1 and rs2 are equal or unequal respectively. BLT (branch if less than) and BLTU (branch if less than, unsigned) may take the branch if rs1 is less than rs2, using signed and unsigned comparison respectively. BGE (branch if greater than or equal to) and BGEU (branch if greater than or equal to, unsigned) may take the branch if rs1 is greater than or equal to rs2, using signed and unsigned comparison respectively. Compressed RISC-V instructions may include instructions such as C.BEQZ (branch if zero, compressed instruction) and C.BNEZ (branch if not zero, compressed instruction).

Uncompressed branching instruction 600 includes six different fields. Uncompressed opcode 601 is “1100011;” opcode 601 ends with “11,” indicating that the instruction is uncompressed. The entire opcode 601 indicates that instruction 600 is a B-type instruction. Other fields of uncompressed instruction 600 include funct3 603, immediate value part II 604, second source register (rs2) 605, first source register (rs1) 606, and immediate value part II 607. Funct3 603 indicates which operation the instruction refers to, in this case “000” or “BEQ,” meaning that the branch will be taken if the first operand and the second operand are equal. First source register 606 indicates where to find one of the operands of the operation, in this case “00001” or register “x1.” Second source register 605 indicates where to find the other operand of the operation, in this case “00000” or register “x0” which is always zero. Immediate value part II 604 and immediate value part II 607 together indicate an offset that specifies the distance to branch from the current program counter if the branch condition is met. This immediate value is used to calculate the target address for the branch. The corresponding offset may be a signed 12-bit immediate value and may be added to the current program counter to determine the target address. In the example of FIG. 6, the immediate value, or offset, is “000000000100” and corresponds to the value “4” (bit 31 may be used to indicate sign).

Compressed branching instruction 650 includes five different fields. The compressed opcode 651 is “01,” indicating that the instruction is compressed. Funct3 655 indicates which operation the instruction refers to, in this case “110” or “C.BEQZ.” Source register 653 indicates where to find an operand of the operation. In this case, source register 653 is “00001” or register “x1.” The other operand for the operation is zero, as indicted by the instruction C.BEQZ, which compares the value in source register 653 to zero. Immediate value part I 652 and immediate value part II 654 together indicate an offset that specifies the distance to branch from the current program counter if the branch condition is met. This immediate value is used to calculate the target address for the branch. In the example of FIG. 6, the immediate value, or offset is “00100010” and corresponds to the value “4.” In specific embodiments, fields may contain fewer bits than allotted and padding bits may be added to the instruction such that the compressed instruction length is 16-bits.

Opcode 601 (e.g., a leading group of bits) may be read by a pre-decoder circuit to determine the instruction type associated with the location of the cache storing instruction 600. A pre-decoded instruction cache may store data indicative of the instruction type and the branch instruction type as an entry. The values in the leading group of bits (e.g., opcode 601, bits 0-6) can indicate that instruction 600 is a branching instruction. If pre-decoder circuit identifies instruction 600 as an uncompressed branching instruction, then pre-decoder circuit may read funct3 603 of instruction 600 to identify the branch type (e.g., bits 12-14, three bits at a location in the cache located five bits after the leading group of bits). For example, bits 12-14 may indicate the branch type of instruction 600. The values to make the determination of what type of branch (if any) corresponds to instruction 600 can be hard coded in the pre-decoder circuit or they can be programmed into a lookup table that is accessible to the pre-decoder circuit. For example, branch instructions, each with opcode “1100011” may include BEQ (funct3 “000”), BNE (funct3 “001”), BLT (funct3 “100”), BGE (funct3 “101”), BLTU (funct3 “110”), and BGEU (funct3 “111”).

Opcode 651 (e.g., part of a leading group of bits) may be read by a pre-decoder circuit to determine the instruction type associated with the location of the cache storing instruction 650. A pre-decoded instruction cache may store data indicative of the instruction type and the branch instruction type as an entry. The values in the leading group of bits (e.g., opcode 601, bits 0-6) can indicate that instruction 600 is a branching instruction. If pre-decoder circuit identifies instruction 650 as a compressed branching instruction, then pre-decoder circuit may read funct3 655 of instruction 650 to identify the branch type (e.g., bits 13-15, three bits at a location in the cache six bits after the leading group of bits). For example, bits 13-15 may indicate the branch type of instruction 650. The values to make the determination of what type of branch (if any) corresponds to instruction 650 can be hard coded in the pre-decoder circuit or they can be programmed into a lookup table that is accessible to the pre-decoder circuit. For example, compressed branch instructions, each with opcode “01” may include C.BEQZ (funct3 “110”) and C.BNEZ (funct3 “111”).

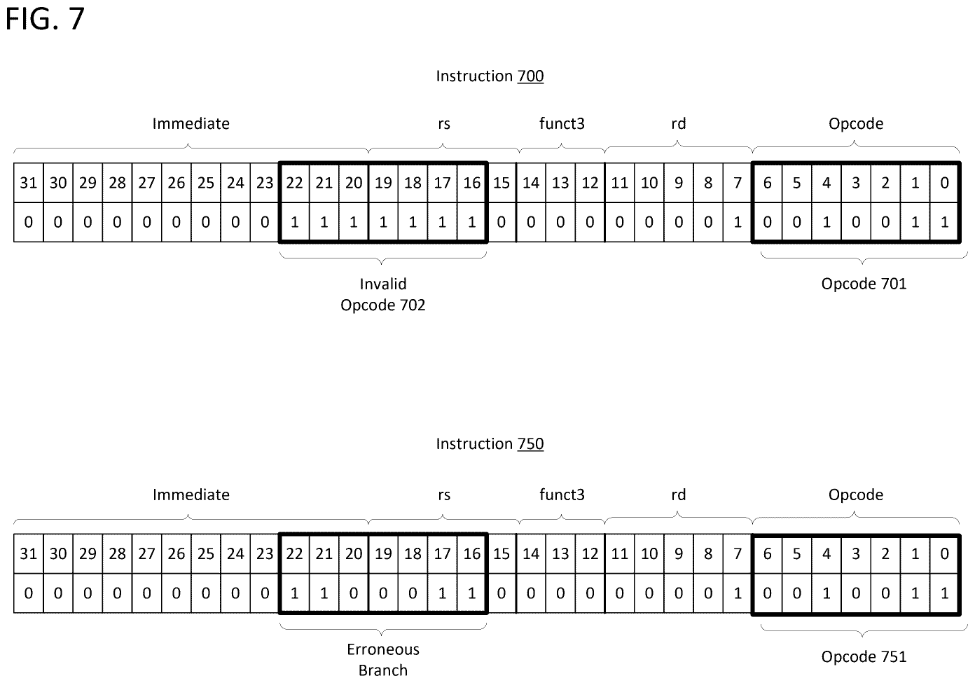

FIG. 7 illustrates an example of invalid opcode 702 in the middle of 4-byte instruction 700 and erroneous branch opcode 752 in the middle of 4-byte instruction 750 in accordance with specific embodiments of the inventions disclosed herein. In specific embodiments, a pre-decoder circuit reads 7 bits of a cache every 2 bytes. If a set of instructions is made up of 2-byte instructions, then the read bits refer to leading groups of bits (e.g., opcodes, headers). If a set of instructions includes 4-bytes instructions (e.g., in addition to 2-byte instructions), then some read bits may not refer to opcodes or headers of an instruction. In other words, the bits read at some locations may not be aligned with any instruction (e.g., refer to the middle “random” bits of an instruction).

In specific embodiments, random values in the center of an instruction can be recognized as invalid (e.g., not referring to an instruction header). A pre-decoder circuit may read opcode 701 of instruction 700 and may store information about instruction 700 as an entry in a pre-decoded instruction cache. Opcode 701 may identify an instruction type of instruction 700 (e.g., ADDI) and a length of instruction 700 (e.g., 4-bytes). Pre-decoder circuit may also read bits 16-22 of instruction 700, as these bits correspond to the 2-byte mark of the instruction (2-bytes from the previous read) and may store information about bits 16-22 as an entry in a pre-decoded instruction cache. Bits 16-22 may refer to invalid opcode 702. The processing system, after the pre-decoding process, may recognize invalid opcode 702 as invalid, and resolve any errors. For example, the processing system may refrain from fetching an “instruction” from the location in the cache that invalid opcode 702 refers to.

In specific embodiments, random values in the center of an instruction can be misinterpreted as identifying instructions (e.g., branching instructions). A pre-decoder circuit may read opcode 751 of instruction 750 and may store information about instruction 750 as an entry in a pre-decoded instruction cache. Opcode 751 may identify an instruction type of instruction 750 (e.g., ADDI) and a length of instruction 750 (e.g., 4-bytes). Pre-decoder circuit may also read bits 16-22 of instruction 750, as these bits correspond to the 2-byte mark of the instruction (2-bytes from the previous read) and may store information about bits 16-22 as an entry in a pre-decoded instruction cache. Bits 16-22 may refer to erroneous branch opcode 752. Erroneous branch opcode, by chance, may refer to a code that a processor recognizes as an instruction (in this example, a branching instruction “1100011”), despite these bits not actually referring to an instruction header or being aligned with an instruction. As shown in FIG. 7, bits 16-22 that make up erroneous branch opcode 752 actually refer to a portion of the register source field (e.g., which corresponds to bits 15-19) and a portion of the immediate field (e.g., which corresponds to bits 20-31). That is, there is no branching instruction despite the pre-decoder circuit reading a set of binary bits that seem to indicate a branching instruction. The processing system, after the pre-decoding process, may read the entry in the pre-decoded instruction cache associated with erroneous branch opcode 752 and an error may occur. In specific embodiments, the error may be resolved as part of the chaining process and the error may not propagate downstream (e.g., the error is invisible to the overall machine). Errors such as these are minimal and any overhead associated with correcting them has a minimal impact on overall performance compared to the improvement in processing time for every cache line processed by the pre-decoder.

Data can be stored for each location (location of bits 0-6 and location of bits 16-22) in the set of instructions regardless of whether leading bits of an instruction are located at that location (e.g., whether the bits refer to an instruction opcode or header). Most values read from a random portion of an instruction (e.g., non-header bits 16-22 of an uncompressed instruction) are likely to resolve to a value which indicates that the instruction is not a branching instruction. In specific embodiments, misidentifying a location of the cache as referring to a branching instruction may cause more errors or more latency than misidentifying a location of the cache as referring to a different type of instruction because branching instructions may cause a jump to another program address if a condition is true. In specific embodiments, the errors may be resolved as part of the chaining process and the errors may not propagate downstream. Errors such as these are minimal and any overhead associated with correcting them has a minimal impact on overall performance compared to the improvement in processing time for every cache line processed by the pre-decoder.

In specific embodiments, the random values of bits 16-22 (erroneous branch opcode 752) in the center of uncompressed instruction 750 can be misinterpreted as identifying branching instructions, and random errors may occur, such that erroneous entries will not be screened out during the chaining processes. However, in these embodiments, the processor may still be able to, at a later time, identify an erroneous execution using various standard checks in the processing pipeline. In such a case, the processor can back up and flush the instruction cache and thereby recover from the mistake. It has been determined that the increase in these errors and the overhead associated with correcting them has a minimal impact on overall performance compared to the improvement in processing time for every cache line processed by the pre-decoder. For example, it may be rare that a set of seven “random” bits in an instruction refer to a specific 7-bit code for branching instructions or other specific 7-bit code that may be detrimentally misinterpreted.

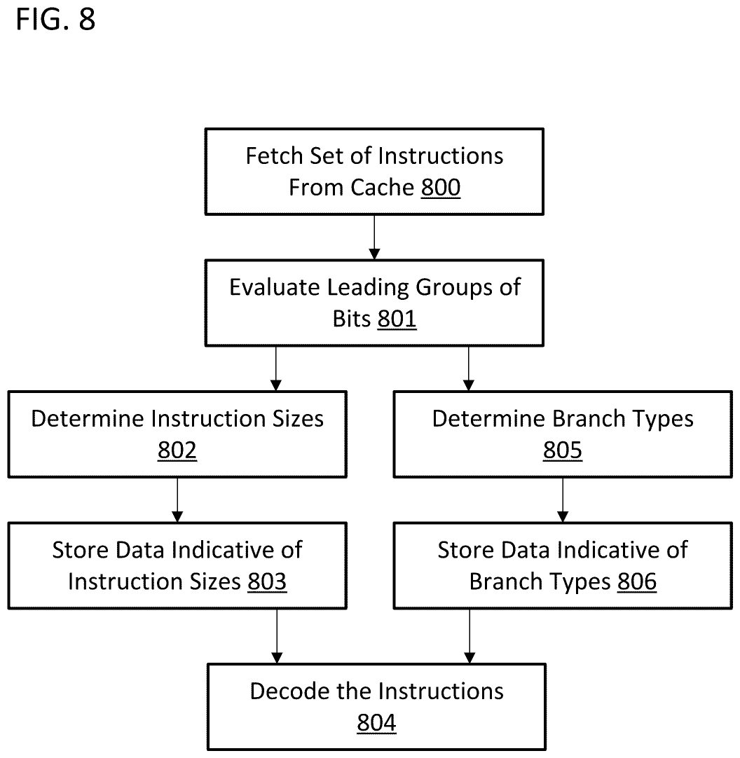

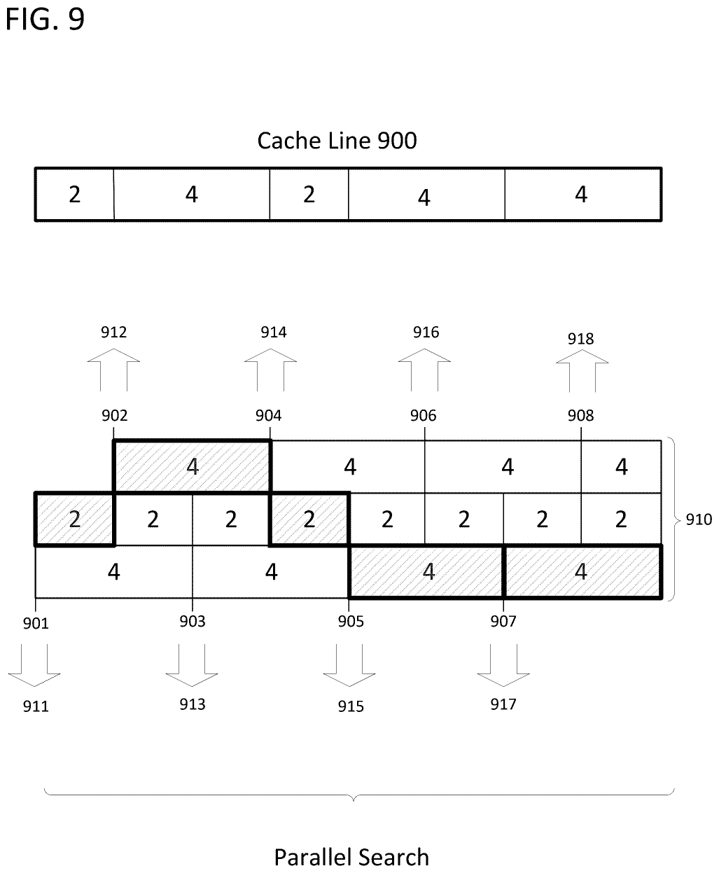

FIG. 8 illustrates a flowchart for a method for decoding instructions in accordance with specific embodiments of the inventions disclosed herein. FIG. 9 illustrates cache line 900 on which the flowchart may operate. The flowchart begins with step 800 of fetching a set of instructions from cache line 900 from a next level cache (e.g., an L2 cache). Cache line 900 can be a 64-byte cache line. In the example of FIG. 9, the set of instructions may include, in order, a 2-byte instruction, a 4-byte instruction, a 2-byte instruction, a 4-byte instruction, and another 4-byte instruction. The set of instructions can be fetched in one piece in a single clock cycle or in multiple pieces across multiple clock cycles. For example, 32-bytes of instructions could be fetched in a first cycle and a second 32-bytes of instructions could be fetched in a second clock cycle. The step can be conducted by a controller of a processor. The step can be conducted using a bus that connects the L2 cache data response bus to a pre-decoder circuit. The step can involve delivering the set of instructions to a fixed location in the pre-decoder circuit that is used to store data for evaluation by the pre-decoder circuit.

The flowchart of FIG. 8 continues with step 801 of evaluating, in parallel and using a pre-decoder circuit, a set of leading groups of bits in the set of instructions at a set of locations 901, 902, 903, 904, 905, 906, 907, and 908 in the set of instructions. The step can involve connecting fixed locations 901 through 908 at which the set of instructions are stored to combinatorial logic that is configured to evaluate the leading groups of bits in the set of instructions. For example, the set of locations 901 through 908 could be at every 2-bytes along the set of instructions. The set of leading groups of bits can have various lengths in different embodiments. For example, the leading groups of bits can each be 7 bits in length and may include the opcode of the instruction. The leading groups could be the length of headers of the instructions. In specific embodiments, the instructions will be evaluated at fixed locations 901 through 908 even though not every location will be associated with the actual header of an instruction. For example, locations 903, 906, and 908 are in the middle of an instruction. This is because this step can be conducted before the chain of instructions has been worked out such that it is not clear where all the instructions start along the cache line. Regardless, in these embodiments, data 911, 912, 913, 914, 915, 916, 917, and 918 can still be read from locations 901, 902, 903, 904, 905, 906, 907, and 908 respectively, which locations are where leading group of bits are expected to be. The data obtained in this manner can then be resolved later when chaining the instructions during a decode operation.

In specific embodiments of the inventions disclosed herein, the set of locations 901 through 908 are spaced apart along the set of instructions that is evaluated by the pre-decoder circuit. In specific embodiments, locations 901 through 908 are spaced apart by a length of the smallest expected instruction in the set of instructions. For example, in the case of a RISC-V processor with compressed and uncompressed instructions, the smallest expected instruction is a 2-byte compressed instruction. As such, step 801 would be conducted at a set of locations that are spaced apart by 2-bytes. In specific embodiments, the lengths of the expected instructions in the set of instructions are multiples of the length of the smallest expected instructions. For example, in the case of a RISC-V processor with compressed and uncompressed instructions, the 2-byte and 4-byte instruction lengths are multiples of the length of the 2-byte instruction. In these embodiments, benefits are realized in that searching at locations that are spaced apart by the length of the smallest instruction will search every potential starting point for an instruction in the set of instructions even if the composition of the set of instructions is not known ex ante.

In specific embodiments of the inventions disclosed herein, step 801 is conducted in parallel across the entire set of instructions. For example, in a 32-byte set of instructions, 16 parallel operations can be conducted to evaluate the leading groups of bits (e.g., read data) at a set of locations that are each 2 bytes apart across the set of instructions. FIG. 9 provides an illustration of this process for a simplified 16-byte cache line having a set of 5 instructions. The parallel search is shown below the diagram of the set of possible instructions 910 and shows all the potential locations (e.g., locations 901 through 908) of the instructions of the various lengths that could be in the set of instructions. The top level of 4-byte instructions is shown with an offset from the start of the set of possible instructions 910 because instructions can span the cache line or breaks in the cache line that are caused by how the instructions are fetched from the cache. The instructions of the set of possible instructions 910 that refer correctly to cache line 900 have bolded outlines and striped boxes.

In specific embodiments of the invention, when the evaluation takes place, the leading set of bits will indicate the length of the instruction. For example, the leading set of bits at a location may indicate if the instruction is a compressed instruction or an uncompressed instruction because that information is stored in the header of an instruction. As such, and as illustrated, the parallel searches will be able to identify when they have properly found a 2-byte or 4-byte instruction. In specific embodiments, this data will be stored in an entry in the pre-decoded instruction cache. However, the parallel searches will also read data (data 911 through 918) at a specific location (e.g., each of location 901 through 908), which may be assumed to be leading sets of bits, but that are actually bits in the center of an instruction. For example, the data 913 from location 903 (e.g., a middle entry) records a value of 2-bytes for the length of the instruction that starts at location 903. However, that is just because the middle of the 4-byte instruction between location 902 and 904 has bits which line up with an indication that the “instruction” at location 903 is 2-bytes in length. That is, data 913 erroneously refers to a non-existent 2-byte instruction. Regardless, data 913 is saved and errors or mistakes may then be resolved during chaining of the set of instructions or may not be resolved and the processor may identify an invalid instruction and conduct a flush operation to revolve the error. Similarly, errors may occur for data 916 and data 918 which also refer to locations (locations 906 and 908 respectively) that are not aligned with instructions. As locations 901, 902, 904, 905, and 907 respectively are aligned with instructions, data 911, 912, 914, 915, and 917 may correctly refer to leading groups of bits. These leading groups of bits may indicate values of 2-bytes, 4-bytes, 2-bytes, 4-bytes, and 4-bytes for the length of instructions that start at locations 901, 902, 904, 905, and 907 respectively.

The flowchart in FIG. 8 continues with step 802 of determining, from the set of leading groups of bits, a set of instruction sizes associated with the set of locations, and step 803 of storing data indicative of the set of instruction sizes in a set of entries in a pre-decoded instruction cache. These values can be determined based on hard coded logic which knows how the length of the instruction is encoded in the set of leading groups of bits. The values can alternatively be determined by a lookup table that can be programmed to find those values. The values can be stored for every location that is evaluated (e.g., locations 901 through 908), not just the locations where an actual start of an instruction was found (e.g., locations 901, 902, 904, 905, and 907). This pre-decoding process, which assumes the distribution of the instructions and collects information without filtering it, provides beneficial information for a later decoding stage while being fairly light-weight itself.

The flowchart in FIG. 8 also continues with step 805 of determining, from the set of leading groups of bits, a set of branch instruction types associated with the set of locations 901 through 908 and step 806 of storing data indicative of the set of branch instruction types in the set of entries in the pre-decoded instruction cache. The step can be conducted similarly to step 802 in that the values in the leading group of bits can indicate what kind of instruction or what kind of branching instruction is implicated by the instruction. The values to make this determination can be hard coded in the pre-decoder circuit or they can be programmed into a lookup table that is accessible to the pre-decoder circuit. As with step 803, data can be stored at step 806 for each location 901 through 908 in the set of instructions regardless of whether leading bits of an instruction are located at that location. The entries can include an encoding of a value which indicates that the instruction is not a branching instruction. Most values read from a random portion of an instruction are likely to resolve to a value which indicates that the instruction is not a branching instruction. As illustrated in FIG. 9, location 903 lines up with the middle of a 4-byte instruction. As such, the bits at location 903 are likely not going to match a type of branching instruction and the corresponding entry that will be stored in the pre-decoded instruction cache will indicate that there is no branching instruction associated with location 903 in the set of instructions. Similarly, the bits at locations 906 and 908 are likely not going to match a type of branching instruction and the corresponding entry that will be stored in the pre-decoded instruction cache will indicate that there is no branching instruction associated with locations 906 and 908.

The flowchart continues to step 804 of decoding the instructions using a decoder circuit and the set of entries. The set of entries can be used to chain the instructions with invalid entries being screened out at this point in the process. In keeping with the example of FIG. 9, since the instruction at location 902 has been properly identified in the pre-decoded instruction cache as a 4-byte instruction, the subsequent entry (associated with data 913 at location 903) can be skipped since the decoder circuit will be able to discern that there is no instruction at location 903. Using this approach, the chaining of the set of instructions can be conducted in a single step. In specific embodiments, the process of decoding the instructions can also be conducted rapidly because branching instructions, and the type of branching instructions, have already been identified. This greatly simplifies the decode process. In specific embodiments, random values in the center of an instruction can be misinterpreted as identifying branching instructions, and random errors may occur, such that erroneous entries will not be screened out during the chaining processes. However, in these embodiments, the processor will still be able to, at a later time, identify an erroneous execution using various standard checks in the processing pipeline. In such a case, the processor can back up and flush the instruction cache and thereby recover from the mistake. It has been determined that the increase in these errors and the overhead associated with correcting them has a minimal impact on overall performance compared to the improvement in processing time for every cache line processed by the pre-decoder.

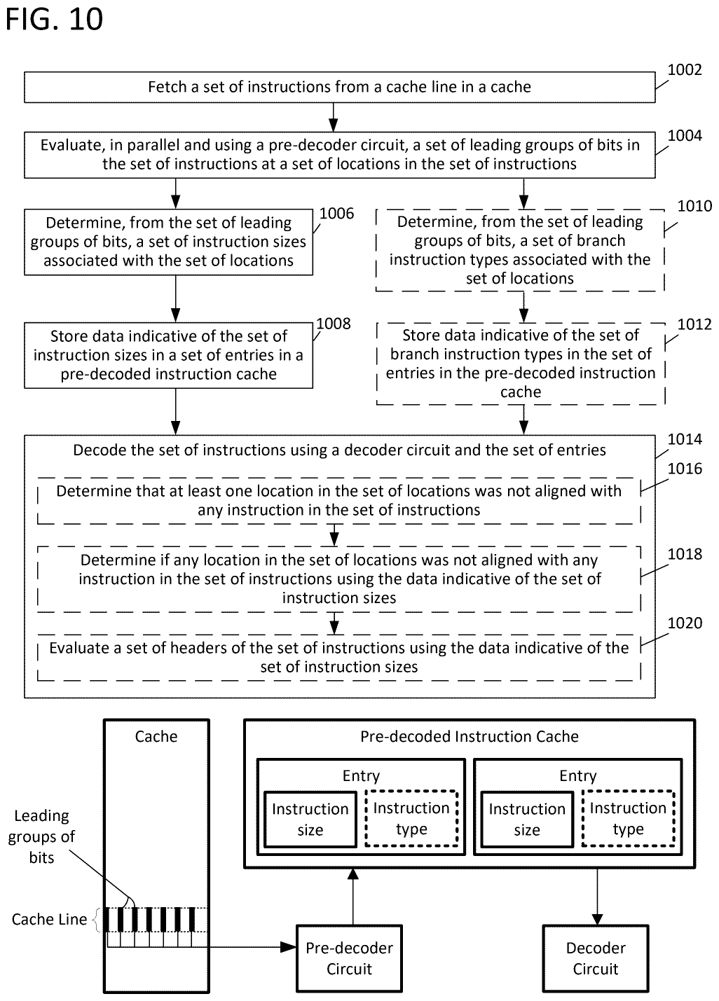

FIG. 10 illustrates an example of method 1000 of operating or performing an instruction caching scheme in accordance with specific embodiments of the inventions disclosed herein. Method 1000 may be implemented by a system including a cache, a pre-decoder circuit, a pre-decoded instruction cache, and a decoder circuit. In specific embodiments, the system may also include a RISC-V processor. In specific embodiments, method 1000 is conducted by a RISC-V processor. In specific embodiments, method 1000 may be implemented by a system including means for performing each step. Steps or portions of steps of method 1000 may be omitted, duplicated, rearranged, performed in parallel, or otherwise deviate from the form shown. For example, in specific embodiments, the evaluating of the set of leading groups of bits (e.g., step 1004), the determining of the set of instruction sizes (e.g., step 1006), and the storing of the data indicative of the set of instruction sizes (e.g., step 1008) are all conducted together in a single clock cycle.

At step 1002, a set of instructions may be fetched from a cache line in a cache. In specific embodiments, the set of instructions may include at least one compressed instruction and at least one uncompressed instruction.

At step 1004, a set of leading groups of bits in the set of instructions at a set of locations in the set of instructions may be evaluated. The set of leading groups of bits may be evaluated in parallel and using a pre-decoder circuit. The set of locations may be spaced apart by a length of a smallest expected instruction in the set of instructions.

At step 1006, a set of instruction sizes associated with the set of locations may be determined. The lengths of expected instructions in the set of instructions may be multiples of the length of the smallest expected instruction. For example, the smallest expected instruction may be 2-bytes and expected instructions may be 2-bytes or 4-bytes. In specific embodiments, the length of the smallest expected instruction is the length of a compressed instruction (e.g., the at least one compressed instruction in the set of instructions).

At step 1008, data indicative of the set of instruction sizes may be stored in a set of entries in a pre-decoded instruction cache. In specific embodiments, the evaluating of the set of leading groups of bits (e.g., step 1004), the determining of the set of instruction sizes (e.g., step 1006), and the storing of the data indicative of the set of instruction sizes (e.g., step 1008) are all conducted together in a single clock cycle.

In specific embodiments, at step 1010, a set of branch instruction types associated with the set of locations may be determined. The set of branch instruction types associated with the set of locations may be determined from the set of leading groups of bits. In specific examples, the set of leading groups of bits may indicate that an instruction is branch type, in which case a pre-decoder may evaluate a set of bits (e.g., corresponding to funct3) within the set of instructions that may refer to the type of branch (e.g., BEQ, BNE, BLT, etc.). In specific embodiments, step 1010 and step 1006 may be performed in parallel.

In specific embodiments, at step 1012, data indicative of the set of branch instruction types (e.g., determined at step 1010) may be stored in the set of entries in the pre-decoded instruction cache. In specific embodiments, step 1012 and step 1008 may be performed in parallel.

At step 1014, the set of instructions may be decoded using a decoder circuit and the set of entries (e.g., the entries stored at step 1008).

In specific embodiments, and as part of decoding the set of instructions (e.g., step 1014), at step 1016, the system may determine that at least one location in the set of locations was not aligned with any instruction in the set of instructions. For example, the at least one location may refer to a location in the middle of an instruction (e.g., middle bits in a 4-byte instruction) that do not refer to an instruction header or opcode.

In specific embodiments, and as part of decoding the set of instructions (e.g., step 1014), at step 1018, the system may determine if any location in the set of locations was not aligned with any instruction in the set of instructions. The determination may be made using the data indicative of the set of instruction sizes. For example, if the set of locations are spaced apart by 2 bytes and data indicative of an instruction indicates that the instruction is 4-bytes, then the location 2 bytes from the 4-byte instruction may refer to the middle of that instruction and is thus not aligned with any instruction (e.g., opposed to being aligned with an instruction via an instruction header). In specific embodiments, locations that are not aligned with instruction headers may be resolved or discarded. In specific embodiments, determining if any location in the set of locations was not aligned with any instruction in the set of instructions (e.g., step 1018) may be conducted within a single clock cycle.

In specific embodiments, and as part of decoding the set of instructions (e.g., step 1014), at step 1020, a set of headers of the set of instructions may be evaluated using the data indicative of the set of instruction sizes (e.g., determined at step 1006). For example, the set of headers may be evaluated to determine instruction type, branch type, or other information. In specific embodiments, the evaluated set of headers of the set of instructions may be used in one or more chaining operations.

In specific embodiments, method 1000 may be implemented by a system including means for performing each step. The means may include or be implemented on or using one or more processors, microprocessors, embedded processors, digital signal processors, media processors, multi-processors, controllers, microcontrollers, processing cores, chiplets, integrated circuits, busses, addressable busses, wires, couplings, wireless communications, memory (e.g., DRAM, SRAM, cache, registers, etc.), logic, amplifiers, etc. More specific means associated with each step of method 1000 are provided below.

For example, step 1002 (e.g., fetching a set of instructions from a cache line in a cache) may be performed using a means for fetching a set of instructions from a cache line in a cache. The means for fetching a set of instructions from a cache line can include a pre-decoder circuit and a coupling from a cache memory to the pre-decoder circuit. For example, the pre-decoder circuit could be pre-decoder circuit 101 and the cache memory could be cache 100. The means for fetching a set of instructions could include a memory management unit and one or more cache controllers. The means for fetching the set of instructions could include the hardware features mentioned above configured to breakdown a memory address request with a requested memory address into a tag and an index. The index can locate the cache line within the cache and the tag can verify if the cache line at the index location actually corresponds to the requested memory address. The hardware features mentioned above could also be configured to then determine if there was a cache miss using the tag and index, update the cache by updating the tag, and data if needed, and deliver the data to the pre-decoder circuit to complete the fetch.

In specific embodiments, step 1004 (e.g., evaluating a set of leading groups of bits) may be performed using a means for evaluating a set of leading groups of bits. The means for evaluating the set of leading groups of bits can be combinatorial logic including a set of logic gates coupled to registers containing the set of leading groups of bits and the connections between them. The means for evaluating the set of leading groups of bits can include a lookup table to evaluate the leading groups of bits. The logic gates can be connected to the registers in spaced apart fashion across the registers that hold the set of instructions. The spacing can be in accordance with the minimum expected instruction size of the instructions in the cache. For example, the combinatorial logic can be combinatorial logic 206, and the connections can be connections 208. The lookup table can be lookup table 207. The means for evaluating the set of leading groups of bits could include logic gates such as AND, OR, XOR, etc., comparators, and hardware-encoded information. The means for evaluating the set of leading groups of bits could include the hardware features mentioned above configured to obtain the signals stored in registers and provide them to the combinatorial logic circuit. The means for evaluating the set of leading groups of bits could also include the hardware mentioned above configured to conduct combinatorial logic operations on the signals and generate an output representing the result of the evaluation.

In specific embodiments, step 1006 (e.g., determining a set of instruction sizes) may be performed using a means for determining a set of instruction sizes. The means for determining the set of instruction sizes can be combinatorial logic including a set of logic gates. The means for determining the set of instruction sizes can include a lookup table to determine the set of instruction sizes. For example, the combinatorial logic can be combinatorial logic 206 and the lookup table can be lookup table 207. The means for determining the set of instruction sizes could include logic gates such as AND, OR, XOR, etc., comparators, and hardware-encoded information. The means for determining the set of instruction sizes could include the hardware features mentioned above configured to compare the leading groups of bits to the lookup table. The means for determining the set of instruction sizes could also include the hardware mentioned above configured to conduct combinatorial logic operations on the leading groups of bits to match each leading group of bits in the set of leading group of bits to an instruction size and generate an output representing the result of the determination.

In specific embodiments, step 1008 (e.g., storing data indicative of the set of instruction sizes) may be performed using a means for storing data indicative of the set of instruction sizes. The means for storing data indicative of the set of instruction sizes can be combinatorial logic coupled to a memory where the coupling comprises a set of connections. The means storing data indicative of the set of instruction sizes can include memory (e.g., internal memory, external memory) with one or more memory cells to store data indicative of the set of instruction sizes. The means for storing data indicative of the set of instruction sizes could include different types of memory, for example a combination of CPU memory, register memory, cache memory, random access memory (RAM), dynamic random access memory (DRAM), static random access memory) SRAM, read only memory (ROM), programmable read only memory (PROM), masked read only memory (MROM), erasable programmable read only memory (EPROM), electrically erasable programmable read only memory (EEPROM), magnetic tape memory, magnetic disk memory, optical disk memory, etc. The combinatorial logic can be connected to the memory in spaced apart fashion across the combinatorial logic that determines the instruction sizes. The spacing can be in accordance with the minimum expected instruction size of the instructions in the cache (e.g., similar to the spacing of the logic gates connected to the registers at step 1004). For example, the memory can be pre-decoded instruction cache 202, the combinatorial logic can be combinatorial logic 206, and the connections can be connections 209. The means for storing data indicative of the set of instruction sizes could include the hardware features mentioned above configured to obtain the signals from the combinatorial logic circuit. The means for storing data indicative of the set of instruction sizes could also include the hardware mentioned above configured to hold an electric charge, hold a magnetic orientation, or otherwise hold a state.

In specific embodiments, step 1010 (e.g., determining a set of branch instruction types) may be performed using a means for determining a set of branch instruction types. The means for determining the set of branch instruction types can be combinatorial logic including a set of logic gates. The means for determining the set of branch instruction types can include a lookup table to determine the set of branch instruction types. For example, the combinatorial logic can be combinatorial logic 206 and the lookup table can be lookup table 207. The means for determining the set of branch instruction types could include logic gates such as AND, OR, XOR, etc., comparators, and hardware-encoded information. The means for determining the set of branch instruction types could include the hardware features mentioned above configured to compare the leading groups of bits to the lookup table. The means for determining the set of branch instruction types could also include the hardware mentioned above configured to conduct combinatorial logic operations on the leading groups of bits to match each leading group of bits in the set of leading group of bits to stored information in the lookup table a branch instruction type and generate an output representing the result of the determination.

In specific embodiments, step 1012 (e.g., storing data indicative of the set of branch instruction types) may be performed using a means for storing data indicative of the set of branch instruction types. The means for storing data indicative of the set of branch instruction types can be combinatorial logic coupled to a memory where the coupling comprises a set of connections. The means for storing data indicative of the set of branch instruction types can include memory (e.g., internal memory, external memory) with one or more memory cells to store data indicative of the set of branch instruction types. The means for storing data indicative of the set of branch instruction types could include different types of memory, for example one of or a combination of electronic memory, magnetic memory, photonic memory, CPU memory, register memory, cache memory, RAM, DRAM, SRAM, ROM, PROM, MROM, EPROM, EEPROM, magnetic tape memory, magnetic disk memory, optical disk memory, etc. The combinatorial logic can be connected to the memory in spaced apart fashion across the combinatorial logic that determines the branch instruction types. The spacing can be in accordance with the minimum expected instruction size of the instructions in the cache (e.g., similar to the spacing of step 1008). For example, the memory can be pre-decoded instruction cache 202, the combinatorial logic can be combinatorial logic 206, and the connections can be connections 209. The means for storing data indicative of the set of branch instruction types could include the hardware features mentioned above configured to obtain the signals from the combinatorial logic circuit. The means for storing data indicative of the set of instruction sizes could also include the hardware mentioned above configured to hold an electric charge, hold an optical state, hold a magnetic orientation, or otherwise hold a state.

In specific embodiments, step 1014 (e.g., decoding the set of instructions) may be performed using a means for decoding the set of instructions. The means for decoding the set of instructions can be combinatorial logic including a set of logic gates coupled to a cache containing the set of instructions and coupled to a memory containing information about the set of instructions (e.g., data indicative of the sizes of the instructions, data indicative of a set of branch instruction types). The means for decoding the set of instructions can include a lookup table to decode the set of instructions. The combinatorial logic gates can be connected to the register and the memory such that specific locations in the register are paired with specific locations in the memory. For example, the combinatorial logic can be part of decoder circuit 103, the cache can be cache 100, and the memory can be pre-decoded instruction cache 102. The means for decoding the set of instructions could include logic gates such as AND, OR, XOR, etc., comparators, one or more lookup tables, and hardware-encoded information. The means for decoding the set of instructions could include the hardware features mentioned above configured to obtain the signals stored in the cache and the memory and provide them to the combinatorial logic circuit. The means for decoding the set of instructions could also include the hardware mentioned above configured to conduct combinatorial logic operations on the signals and generate an output representing the result of the decoding.

In specific embodiments, step 1016 (e.g., determining that at least one location in the set of locations was not aligned with any instruction) may be performed using a means for determining that at least one location in the set of locations was not aligned with any instruction. The means for determining that at least one location in the set of locations was not aligned with any instruction can be combinatorial logic including a set of logic gates, a chaining circuit, a decode circuit, or a processor fault detection circuit. The means for determining that at least one location in the set of locations was not aligned with any instruction can include a lookup table to determine the alignment of locations and instructions. For example, the combinatorial logic and the lookup table can be part of decoder circuit 103. The means for determining that at least one location in the set of locations was not aligned with any instruction could include logic gates such as AND, OR, XOR, etc., comparators, and hardware-encoded information. The means for determining that at least one location in the set of locations was not aligned with any instruction could include the hardware features mentioned above configured to compare bits corresponding to the location to the lookup table. The means for determining that at least one location in the set of locations was not aligned with any instruction could also include the hardware mentioned above configured to conduct combinatorial logic operations on bits corresponding to the location to match bits corresponding to each location to a valid instruction header or to an invalid instruction header and generate an output representing the result of the determination. Alternatively, the means for determining that at least one location in the set of locations was not aligned with any instruction could include the hardware mentioned above determined to detect a violation in the chaining process (e.g., a 2-byte instruction detected as being aligned in the middle of a 4-byte instruction indicates that the location of the perceived 2-byte instruction was not in fact aligned with any instruction).

In specific embodiments, step 1018 (e.g., determining if any location in the set of locations was not aligned with any instruction in the set of instructions using the data indicative of the set of instruction sizes) may be performed using a means for determining that at least one location in the set of locations was not aligned with any instruction in the set of instructions using the data indicative of the set of instruction sizes. The means for determining that at least one location in the set of locations was not aligned with any instruction in the set of instructions using the data indicative of the set of instruction sizes can be combinatorial logic including a set of logic gates or a chaining circuit. The means for determining that at least one location in the set of locations was not aligned with any instruction in the set of instructions using the data indicative of the set of instruction sizes can include a memory to retrieve data indicative of the set of instruction sizes. For example, the combinatorial logic can be part of decoder circuit 103 and the memory can be pre-decoded instruction cache 202. The means for determining that at least one location in the set of locations was not aligned with any instruction in the set of instructions using the data indicative of the set of instruction sizes could include logic gates such as AND, OR, XOR, etc., comparators, and hardware-encoded information. The means for determining that at least one location in the set of locations was not aligned with any instruction in the set of instructions using the data indicative of the set of instruction sizes could include the hardware features mentioned above configured to read bits corresponding to instruction sizes and associating instruction sizes with locations. The means for determining that at least one location in the set of locations was not aligned with any instruction in the set of instructions using the data indicative of the set of instruction sizes could also include the hardware mentioned above configured to conduct combinatorial logic operations on bits corresponding to the size of the instruction at the location prior to the misaligned location, to compare the size of the instruction at the location prior to the misaligned location and the length between the location prior to the misaligned location and the misaligned location. The means for determining that at least one location in the set of locations was not aligned with any instruction in the set of instructions using the data indicative of the set of instruction sizes could also include the hardware mentioned above configured to generate an output representing the result of the determination. Alternatively, the means for determining that at least one location in the set of locations was not aligned with any instruction could include the hardware mentioned above determined to detect a violation in the chaining process (e.g., a 2-byte instruction detected as being aligned in the middle of a 4-byte instruction indicates that the location of the perceived 2-byte instruction was not in fact aligned with any instruction).

In specific embodiments, step 1020 (e.g., evaluating a set of headers) may be performed using a means for evaluating a set of headers. The means for evaluating the set of headers can be combinatorial logic including the set of logic gates coupled to memory containing data indicative of the set of instruction sizes. The means for evaluating the set of headers can include a lookup table to evaluate the set of headers. The logic gates can be connected to the memory in spaced apart fashion across the memory that holds data indicative of the set of instruction sizes. The spacing can be in accordance with the minimum expected instruction size of the instructions in the cache. For example, the combinatorial logic and the lookup table can be part of decoder circuit 103 and the memory can be pre-decoded instruction cache 202. The means for evaluating the set of headers could include logic gates such as AND, OR, XOR, etc., comparators, and hardware-encoded information. The means for evaluating the set of headers could include the hardware features mentioned above configured to obtain the signals stored in memory and provide them to the combinatorial logic circuit. The means for evaluating the set of headers could also include the hardware mentioned above configured to conduct combinatorial logic operations on the signals and generate an output representing the result of the evaluation.

While the specification has been described in detail with respect to specific embodiments of the invention, it will be appreciated that those skilled in the art, upon attaining an understanding of the foregoing, may readily conceive of alterations to, variations of, and equivalents to these embodiments. These and other modifications and variations to the present invention may be practiced by those skilled in the art, without departing from the scope of the present invention, which is more particularly set forth in the appended claims.

What is claimed is:

1. A method comprising:
fetching a set of instructions from a cache line in a cache;
evaluating, in parallel and using a pre-decoder circuit, a set of leading groups of bits in the set of instructions at a set of locations in the set of instructions, wherein the set of locations are spaced apart by a length of a smallest expected instruction in the set of instructions, and wherein lengths of expected instructions in the set of instructions are multiples of the length of the smallest expected instruction;
determining, from the set of leading groups of bits, a set of instruction sizes associated with the set of locations;
storing data indicative of the set of instruction sizes in a set of entries in a pre-decoded instruction cache; and
decoding the set of instructions using a decoder circuit and the set of entries.

2. The method of claim 1, further comprising:
determining, from the set of leading groups of bits, a set of branch instruction types associated with the set of locations; and
storing data indicative of the set of branch instruction types in the set of entries in the pre-decoded instruction cache.

3. The method of claim 1, wherein:
the method is conducted by a RISC-V processor;
the set of instructions includes at least one compressed instruction and at least one uncompressed instruction; and
the length of the smallest expected instruction is a length of the at least one compressed instruction.

4. The method of claim 1, wherein:
the evaluating of the set of leading groups of bits, the determining of the set of instruction sizes, and the storing of the data indicative of the set of instruction sizes are all conducted together in a single clock cycle.

5. The method of claim 1, wherein the decoding of the set of instructions using the decoder circuit comprises:
determining that at least one location in the set of locations was not aligned with any instruction in the set of instructions.

6. The method of claim 1, wherein:
the pre-decoder circuit comprises a lookup table and a block of combinatorial logic; and
the pre-decoder circuit conducts the determining of the set of instruction sizes using the lookup table and the block of combinatorial logic.

7. The method of claim 1, wherein decoding the set of instructions using the decoder circuit and the set of entries comprises:
determining if any location in the set of locations was not aligned with any instruction in the set of instructions using the data indicative of the set of instruction sizes; and
evaluating a set of headers of the set of instructions using the data indicative of the set of instruction sizes.

8. The method of claim 7, wherein:
determining if any location in the set of locations was not aligned with any instruction in the set of instructions is conducted within a single clock cycle.

9. A system comprising:
a cache including a cache line storing a set of instructions;
a pre-decoder circuit that evaluates, in parallel, a set of leading groups of bits in the set of instructions at a set of locations in the set of instructions, wherein the set of locations are spaced apart by a length of a smallest expected instruction in the set of instructions, and wherein lengths of expected instructions in the set of instructions are multiples of the length of the smallest expected instruction;
a pre-decoded instruction cache that stores data indicative of a set of instruction sizes in a set of entries, wherein the set of instruction sizes associated with the set of locations is determined from the set of leading groups of bits; and
a decoder circuit that decodes the set of instructions using the set of entries.

10. The system of claim 9, wherein:
a set of branch instruction types associated with the set of locations is determined from the set of leading groups of bits; and
the pre-decoded instruction cache stores data indicative of the set of branch instruction types in the set of entries.

11. The system of claim 9, further comprising:
a RISC-V processor, wherein:
the RISC-V processor operates the cache, the pre-decoder circuit, the pre-decoded instruction cache, and the decoder circuit;
the set of instructions includes at least one compressed instruction and at least one uncompressed instruction; and
the length of the smallest expected instruction is a length of the at least one compressed instruction.

12. The system of claim 9, wherein:
the evaluating of the set of leading groups of bits, the determining of the set of instruction sizes, and the storing of the data indicative of the set of instruction sizes are all conducted together in a single clock cycle.

13. The system of claim 9, wherein:
the decoding of the set of instructions comprises determining, by the decoder circuit, that at least one location in the set of locations was not aligned with any instruction in the set of instructions.

14. The system of claim 9, wherein:
the pre-decoder circuit comprises a lookup table and a block of combinatorial logic; and
the pre-decoder circuit determines the set of instruction sizes using the lookup table and the block of combinatorial logic.

15. The system of claim 9, wherein:
the decoder circuit, as part of decoding the set of instructions using the set of entries, (i) determines if any location in the set of locations was not aligned with any instruction in the set of instructions using the data indicative of the set of instruction sizes; and (ii) evaluates a set of headers of the set of instructions using the data indicative of the set of instruction sizes.

16. The system of claim 15, wherein:
determining, by the decoder circuit, if any location in the set of locations is not aligned with any instruction in the set of instructions is conducted within a single clock cycle.

17. A system comprising:
a means for fetching a set of instructions from a cache line in a cache;
a means for evaluating, in parallel and using a pre-decoder circuit, a set of leading groups of bits in the set of instructions at a set of locations in the set of instructions, wherein the set of locations are spaced apart by a length of a smallest expected instruction in the set of instructions, and wherein lengths of expected instructions in the set of instructions are multiples of the length of the smallest expected instruction;
a means for determining, from the set of leading groups of bits, a set of instruction sizes associated with the set of locations;
a means for storing data indicative of the set of instruction sizes in a set of entries in a pre-decoded instruction cache; and
a means for decoding the set of instructions using a decoder circuit and the set of entries.

18. The system of claim 17, further comprising:
a means for determining, from the set of leading groups of bits, a set of branch instruction types associated with the set of locations; and
a means for storing data indicative of the set of branch instruction types in the set of entries in the pre-decoded instruction cache.

19. The system of claim 17, further comprising:
a RISC-V processor, wherein:
the RISC-V processor operates the cache, the pre-decoder circuit, the pre-decoded instruction cache, and the decoder circuit;
the set of instructions includes at least one compressed instruction and at least one uncompressed instruction; and
the length of the smallest expected instruction is a length of the at least one compressed instruction.

20. The system of claim 17, wherein:
the evaluating of the set of leading groups of bits, the determining of the set of instruction sizes, and the storing of the data indicative of the set of instruction sizes are all conducted together in a single clock cycle.
